(19) United States
(12) Patent Application Publication
(10) Pub. No.: US 2017/0087559 A1
(43) Pub. Date: Mar. 30, 2017

(54) SAFETY SHREDDER WITH JAM CLEAR

(71) Applicant: AURORA OFFICE EQUIPMENT CO., LTD. SHANGHAI, Shanghai (CN)

(72) Inventors: Yung Kang Tso, Shanghai (CN); Wei Liu, Shanghai (CN); GuangLong Chen, Shanghai (CN); Chung Shih Tsai, Hawthorne, CA (US)

(21) Appl. No.: 14/868,137

(22) Filed: Sep. 28, 2015

(51) Int. Cl. B02C 18/22; B02C 18/00

(52) U.S. Cl. CPC B02C 18/2291; B02C 18/0007; B02C 2018/0023; B02C 2018/164

(57) ABSTRACT

A novel safe paper feed opening structure of a paper shredder, having a shredder upper cover and a paper shredder plate. The shredder upper cover has an opening, and the paper shredder plate is at the opening. The opening communicates with a moveable feed throat. The paper shredder plate can be configured in one of four positions. The moveable feed throat has a normal opening and a wide opening. The feed throat can be moved to the wide opening when the shredder plate is in a JAM CLEAR/OFF position. The CLOSED/OFF, NORMAL/ON, and SHRED-SAFE/OFF positions use a normal feed throat. A method for operating a paper shredder includes providing a shredder upper cover; providing the shredder upper cover with an opening; disposing a paper shredder plate at the opening; disposing the opening in communication with a moveable feed throat; and moving the feed throat responsive to a paper shredder condition.

### FIELD OF THE INVENTION

The present invention relates to a safe mechanism for use in a paper shredder. Specifically, it relates to a safety assurance mechanism, particularly a novel safe paper feed jam clearing structure.

### BACKGROUND OF THE INVENTION

Currently, paper feed openings of paper shredders can be divided into three types: a first having an open structure, by which a user can directly feed paper into a paper feed opening for shredding; a second having a sliding-plate structure, by which a user needs to expose the paper feed opening first and feed paper in thereafter; and a third structure, in which a user must lift an access plate in order to be able to feed paper into the shredder. Neither one of the first two structures are directly connected to a circuit capable of cutting off power to the paper shredder. The third paper feed opening type preferentially cuts off power to the paper shredder so as to actively protect users from accidentally feeding parts of their bodies or their personal belongings into a paper feed opening. However, none have a mechanism by which shredder jams may be relieved safely while maintaining active protection of the user.

### SUMMARY

Apparatus embodiments herein provide a novel safe paper feed opening structure of a paper shredder, having a shredder upper cover and a paper shredder plate. The shredder upper cover has an opening, and the paper shredder plate is disposed at the opening. The opening is in communication with a moveable feed throat. The paper shredder plate is configured to be disposed in one of a plurality of positions. The paper feed throat is a moveable feed throat having a normal opening and a wide opening. The paper feed throat moving to the wide opening when the shredder plate is disposed in a preselected one of a plurality of positions. The novel safe paper feed opening structure also may include a touch structure with safe power supply switch. The upper cover can be configured with a safe power supply switch and touch structure, with the touch structure and the safe power supply switch being designed to interact with each other. In the novel safe paper feed opening structure the moveable feed throat includes a moveable throat vane and a fixed throat vane.

In embodiments, the paper shredder plate includes a plurality of positions including a CLOSED position; a NORMAL position; a SHRED-SAFE position; and a JAM CLEAR position. In embodiments, the paper shredder plate further can be disposed in a CLOSED/OFF position; a NORMAL/ON position; a SHRED-SAFE/OFF position; or a JAM CLEAR/OFF position, in which ON pertains to electrical power being supplied to the paper shredder electrical components, and OFF pertains to electrical power being removed from the paper shredder electrical components. The wide opening corresponds to the JAM CLEAR/OFF position. In some embodiments, the fixed throat vane is a portion of the shredder upper cover and the moveable throat vane is a portion of a paper feed board coupled to the shredder upper cover. When the paper shredder plate is disposed in a CLOSED position, a power switch is in its OFF position, and the moveable feed throat is in the NORMAL opening. When the paper shredder plate is disposed in a NORMAL position, a power switch is in its ON position, and the moveable feed throat is in the NORMAL opening. When the paper shredder plate is disposed in a SHRED-SAFE position, a power switch is in its OFF position, and the moveable feed throat is in the NORMAL opening. When the paper shredder plate is disposed in a JAM CLEAR position, a power switch is in its OFF position, and the moveable feed throat is in the WIDE opening.

Other embodiments provide a paper shredder, which includes a shredder upper cover having an opening; a moveable feed throat, including a moveable throat vane and a fixed throat vane; a paper shredder plate being disposed at the opening; a touch structure on the paper shredder plate; and a safe power supply switch configured on the upper cover. The opening is in communication with the moveable feed throat. The paper shredder plate is configured to be disposed in one of a plurality of positions, wherein the moveable feed throat has a NORMAL opening and a WIDE opening corresponding to a selected one of the plurality of positions. The touch structure and the safe power supply switch being designed to interact with each other.

Method embodiments herein provide for operating a paper shredder, including providing a shredder upper cover; providing the shredder upper cover with an opening; disposing a paper shredder plate at the opening; disposing the opening in communication with a moveable feed throat; and moving the moveable feed throat in response to a paper shredder condition. In embodiments, moving the moveable feed throat includes moving the moveable feed throat to a WIDE position in response to a paper shredder JAM condition. Moving the moveable feed throat can be moving the moveable feed throat to a NORMAL position in response to a paper shredder NORMAL condition. In some embodiments, moving the moveable feed throat further includes one of moving the paper shredder plate to a CLOSED/OFF position; moving the paper shredder plate to a NORMAL/ON position; moving the paper shredder plate to a SHRED-SAFE/OFF position; or moving the paper shredder plate to a JAM CLEAR/OFF position. ON pertains to electrical power being supplied to electrical components of the paper shredder, and OFF pertains to electrical power being removed from the electrical components of the paper shredder.

### BRIEF DESCRIPTION OF THE DRAWINGS

The invention is generally shown by way of reference to the accompanying drawings in which:

FIG. 1 is a side view illustration of a shredder, in accordance with the teachings herein;

FIG. 2 shows a cross-section of an embodiment of a paper feed opening structure in accordance with the teachings of the present invention;

FIG. 3 shows a perspective view of the structure of the shaft base of the embodiment shown in FIG. 1, in accordance with the teachings of the present invention;

FIG. 4 shows a cross-section of the embodiment of FIG. 1 showing multiple operating positions of a paper shredder plate, in accordance with the teachings of the present invention;

FIG. 5 shows the cross-section of FIG. 4 in the NORMAL/ON and SHRED SAFE/OFF positions, in accordance with the teachings of the present invention;

FIG. 6 shows a cut-away cross-section structure of the paper shredder plate of FIG. 5, illustrating a the paper shredder plate in the JAM CLEAR/OFF position and the power safe switch in the OFF position, in accordance with the teachings of the present invention;

FIG. 7 illustrates a cut-away of JAM CLEAR/OFF position showing paper shredder plate 400 in the “up and moved back” position in accordance with the teachings of the present invention;

FIG. 8A shows a perspective view of a paper shredder plate, in accordance with the teachings of the present invention;

FIG. 8B shows a perspective view of a paper entrance board, in accordance with the teachings of the present invention;

FIG. 9A shows a perspective view of a paper shredder plate coupled to a paper entrance board in the NORMAL position, in accordance with the teachings of the present invention;

FIG. 9B shows a perspective view of the paper shredder plate coupled to the paper entrance board in the JAM CLEAR position, in accordance with the teachings of the present invention;

FIG. 10 shows a top view of a shredder upper cover, in accordance with the teachings of the present invention; and

FIG. 11 shows a bottom view of the shredder upper cover in FIG. 10, in accordance with the teachings of the present invention.

Some embodiments are described in detail with reference to the related drawings. Additional embodiments, features and/or advantages will become apparent from the ensuing description or may be learned by practicing the embodiment. In the figures, which are not drawn to scale, like numerals refer to like features throughout the description. The following description is not to be taken in a limiting sense, but is made merely for the purpose of describing the general principles of the embodiments.

### DESCRIPTION OF EMBODIMENTS

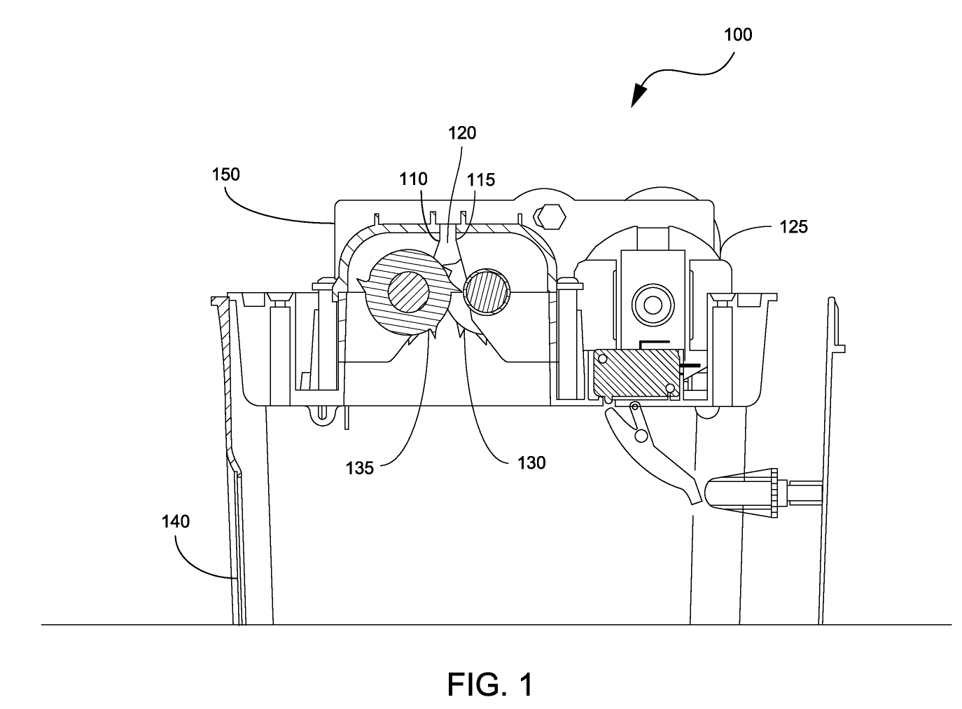

Embodiments provide mechanisms are aimed to do away with paper shredder throat jams. In FIG. 1, exemplary conventional shredder 100 is shown having throat blades 110, 115 forming shredder throat 120 in a paper feed opening structure of a paper shredder (not shown). Material to be shredded (not shown) can be introduced into throat 120, and motor 125 can be activated. Motor 125 ultimately drives shredder blades 130, 135. If the amount of material introduced into throat 120 is not excessive, the shredding material will be comminuted into shreddant. If the amount of material is excessive, a jam can occur from a wad of shredding material in throat 120. In FIG. 1, throat blades 110, 115 can be fixed, rigid metal or plastic blades. At least a portion of one or both throat blades 110, 115 can be moveable. For example, at least a part of throat blade 115 can be moveable. When an excessive amount of material is introduced into shredder 100, throat 120 can become clogged and causing shredder blades 130, 135 to jam. Typically, a jam requires between about 10 lbs. to about 15 lbs. of force to clear the jam. In accordance with the embodiments herein, a jam may require as little as 1 lb. of force to clear the jam. In the embodiments herein, a shredder jam clear apparatus can be disposed in shredder upper cover 150. The shredder jam clear apparatus can make throat 120 wider when necessary (e.g., during a jam) but otherwise keep throat 120 in its narrower, nominal operating condition for safety.

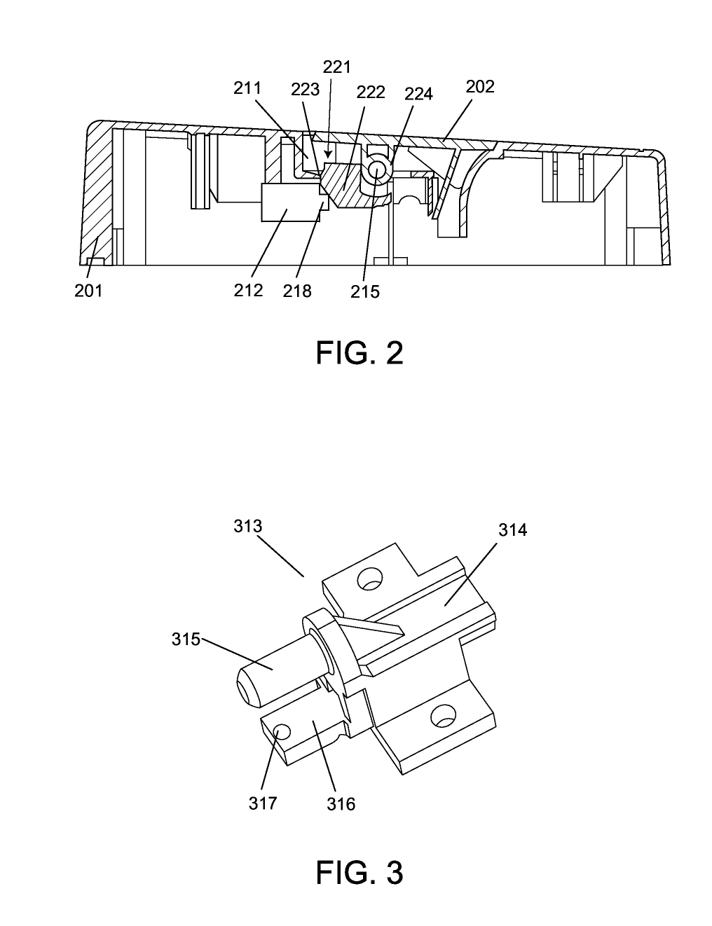

Referring to FIG. 2, an embodiment is presented of a safe paper feed opening structure of a paper shredder, which includes a paper shredder upper cover 201 and a paper shredder paper shredder plate 202, the paper shredder upper cover 201 having an opening, and the paper shredder plate 202 being disposed at the opening. The paper shredder upper cover 201 and the paper shredder plate 202 may be either integrated or separated.

The paper shredder plate 202 can be configured with a touch structure, and the paper shredder upper cover 201 can be correspondingly configured with at least one safe power supply switch 212. The touch structure and the safe power supply switch 212 can be designed to interact with each other, meaning that when the paper shredder plate 202 is closed, the touch structure acts on the safe power supply switch 212 so as to cut off the power supply. When the paper shredder plate 202 is opened, the touch structure can act on the safe power supply switch 212 to allow power. When there is any non-expected item fed in, the non-expected item forces the paper shredder plate 202 up, hence causing the touch structure to act on the safe power supply switch 212 to actively cut off the power supply. A second safe power supply switch (not shown) may be used when opening the throat to extract a jam, and the paper shredder plate is moved up and back away the shredder throat.

With the above technical features, the safe power supply switch 212 has a dual protection function: when the paper shredder plate 202 is closed, the entire circuit is not electrically conductive—this is the first-level protection. When the paper shredder plate is opened during normal operation, the paper shredder plate will cut off the power supply if there are any non-expected items fed in or that accidentally fall into the opening as they will cause a noticeable force that enables the safe power supply switch 212 to cut off power supply—this is the second-level protection. A third-level protection can be obtained by using second safe power supply switch (not shown) during clearing of a jam.

The touch structure paper shredder plate 202 and the safe power supply switch 212 are integrated into one circuit disconnection device that serves as a protection system which actively cuts off the power supply whenever a non-expected item is fed in, and which functions reversely as a passive conducting device while feeding paper through the paper feed opening. The safe power supply switch 212 is a preferential disconnection device. Different from a safe switch or a paper-full switch, whose function is realized by adopting a flip-flop in a circuit of a paper shredder, the safe power supply switch 212 has first-level priority to protect a user.

The paper shredder upper cover 201 and the paper shredder plate 202 refer to any separate or integrated structures able to seal the paper feed opening. The paper shredder plate 202 and the paper shredder upper cover 201 are connected such that the former can move separately relative to the latter. The touch structure is a cam 221 disposed on the paper shredder plate 202. Corresponding to the cam 221, the safe power supply switch 212 is disposed on a corresponding position of the paper shredder upper cover 201. The cam 221 and the safe power supply switch 212 are configured to interact with each other. That is, when the paper shredder plate 202 is opened, the cam 221 acts on the safe power supply switch 212 so as to switch ON the safe power supply switch 212. This can be the NORMAL/ON position. When there is any non-expected item fed in, the cam 221 acts on the safe power supply switch 212 to cut off the safe power supply switch 212 actively. This can be the SHRED SAFE/OFF position. When the paper shredder plate 202 is closed, the cam 221 functions on the safe power supply switch 212 again and cuts it off. This can be the CLOSED/OFF position. Another switch (not shown) is cut off in the JAM CLEAR/OFF position. This provides an additional layer of safety for safe paper feed opening structure of a paper shredder, which protects the user from harm.

In one of the present embodiments, the opening is a notched opening 211 disposed on the paper shredder upper cover 201; the paper shredder plate 202 locates at the notched opening 211; the cam 221 is disposed on the inner surface of the paper shredder plate 202; and the safe power supply switch 212 is disposed inside the paper shredder upper paper shredder upper cover 201.

Referring to FIG. 3, shaft bases 313 are fixed on the two opposite sides inside the paper shredder upper cover 201. The shaft bases 313 each comprise a main base body 314 and a shaft 315 protruding from the main base body 314. Corresponding to the shaft base 313, protruding blocks are fixed on the opposite sides of the inner surface of the paper shredder plate 202. Within each protruding block, a shaft hole can be opened to accommodate the shaft 315.

The shaft base 313 further comprises protrusions 316 each located under the shaft 315 and provided with a protruding point 317 pointing towards the shaft 315, which can provide for multiple operating detents. The fundamental cam 222 can be fixed to the protruding block 224, the cam 221 being indirectly coupled to the paper shredder plate 202.

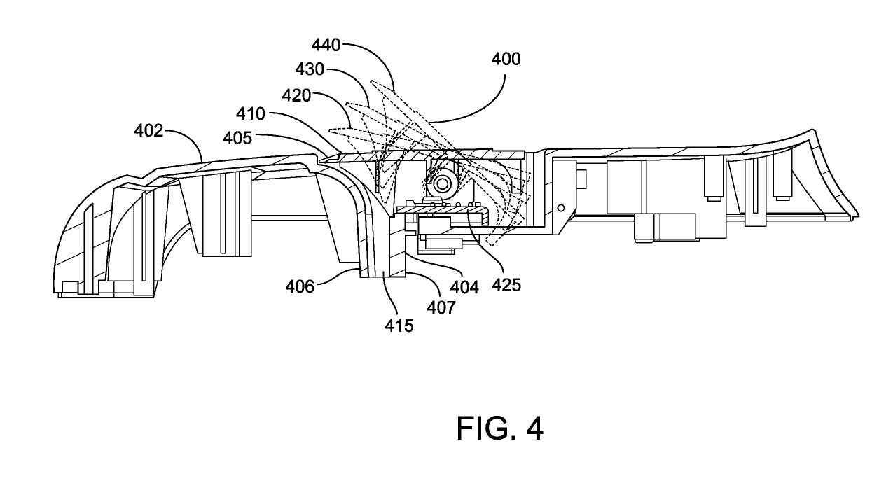

As illustrated in FIG. 4, paper shredder plate 400, according to the present embodiments, can have multiple operating positions. Multi-position paper shredder plate 400 can have, for example, four (4) positions. Paper shredder plate 400 can be attached to shredder upper cover 402. Paper shredder plate 400 can fit into a recess in shredder upper cover 402. Each of the example four (4) positions can be attained by rotating a shredder feed cover, such as paper shredder plate 400, around shaft 425, which may be positioned in one or both lateral sides of paper shredder plate 400. Rotation can be performed by gently lifting paper shredder plate 400 in an up-and-back motion. Paper shredder plate 400 can be coupled at its base to paper entrance board 404. Paper entrance board 404 may itself be coupled to a portion of shredder upper cover 402. Moveable paper shredder plate 400 exposes paper feed throat 415, which directs shreddable material to the shredder blades for comminution. Paper feed throat 415 may have a fixed throat vane 406, which can be a portion of shredder upper cover 402, and a moveable throat vane 407, which can be a portion of paper entrance board 404.

In a position of paper shredder plate 400, paper feed throat 415 may move from nominal gap position to a wide gap position. When transitioning to the wide gap position, paper feed board 404 may move away from shredder upper cover 402 to widen the gap, and may place springs (not shown) under tension. When returning to the nominal gap position paper feed board 404 may move towards shredder upper cover 402 to return the gap to the nominal position. The springs (not shown) under compression may release their compressed position to assist in moving from wide gap position to nominal gap position.

In the first position, which may be the CLOSED/OFF position 410, the paper feed throat 415 can be covered over by the paper shredder plate 400, in contact with a portion of shredder upper cover 402. No shredding may be accomplished through the closed paper feed throat 415. Electrical power can be removed from the shredder motor (not shown) and electronic components (not shown) to prevent operation.

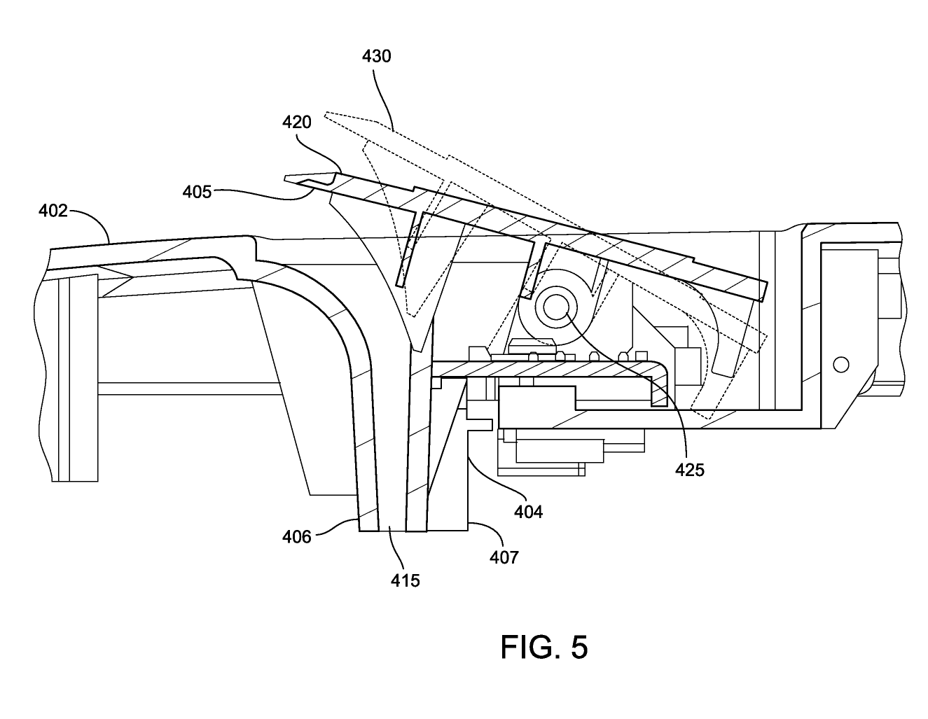

In the second position, which may be the NORMAL/ON position 420, the paper shredder plate 400 can be lifted at outer lip 405 such that the paper feed throat 415 can have a nominal gap, for example, about 3.2 mm wide, which permits normal operation of the shredder for a predetermined rated amount of shreddable material (such as sheets of paper). The predetermined amount may be the rated amount of shreddable material allowed by a particular shredder design. Of course, the nominal gap can be greater or lesser, depending upon the predetermined maximum number of sheets, or rated amount, of shreddable material. Electrical power is supplied to the shredder motor and electronic components to effect shredding. Shredding can be performed by inserting shreddable items into paper feed throat 415 while the power is supplied to the shredder motor and electronic components. The NORMAL/ON position 420 also is illustrated in FIG. 5.

In the third position, which may be the SHRED-SAFE/OFF position 430, the paper shredder plate 400 is pushed up and back, relative to the NORMAL/ON position 420, and the paper feed throat 415 approximately maintains a nominal gap, for example, about 3.2 mm wide. In the SHRED-SAFE/OFF position 430, electrical power is removed from the shredder motor and electronic components. This position 430 can be used as a SAFE position, in which users are protected from injury to their body parts, or belongings, introduced into the moveable paper feed throat 415, because the shredder motor and operating electronics are blocked from functioning. Also, a minor paper jam can be cleared safely from the SHRED-SAFE/OFF position 430. The SHRED-SAFE/OFF position 430 also is illustrated in FIG. 5.

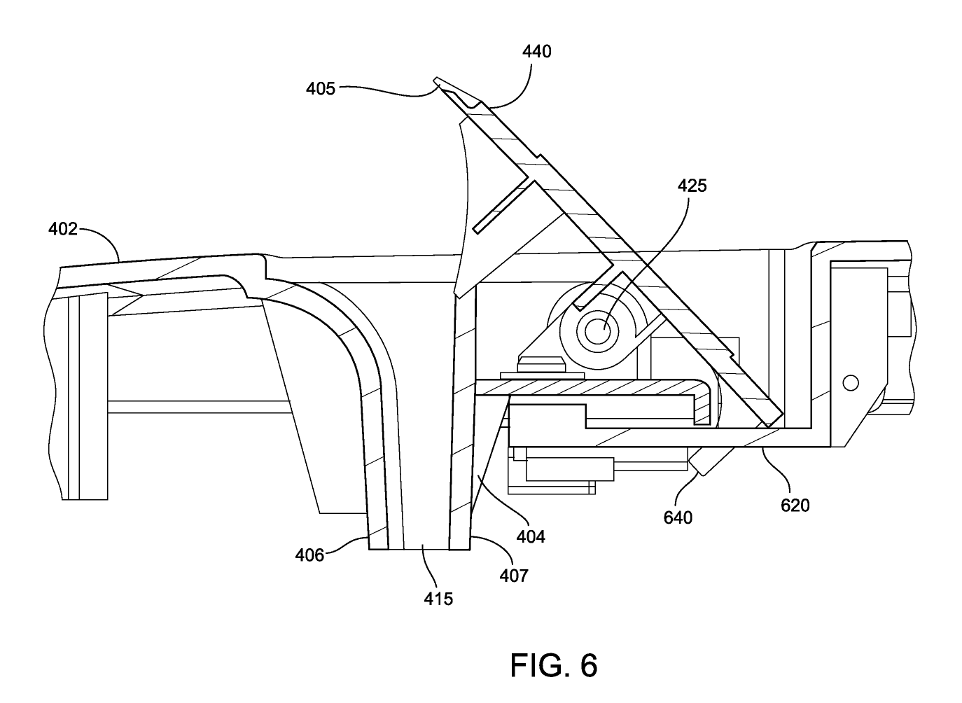

In the fourth position, which may be the JAM CLEAR/OFF position 440, seen in FIGS. 4 and 6, the paper feed throat 415 can be moveable from a nominal gap of about 3.2 mm, for example, by an additional clearance of about 4.0 mm (approx. 7.2 mm total gap, in this example) so that easier removal of paper jams may be accomplished. A moveable paper feed throat 415 may be configured for a greater or lesser paper feed throat 415 width in the fourth position. To accomplish the fourth position, paper shredder plate 400 can be pushed up-and-back relative to the SHRED-SAFE/OFF position 430. Shredder cover tag 610 is depicted as a tab although more than one tag may be used. At least one shredder cover tag 610 can extend downward from paper shredder plate 400 to be releasably captured by aperture 620 in shredder upper cover 402 when paper shredder plate 400 is pushed up-and-back. In this position, shredder cover tag 610 can hold paper shredder plate 400 in position until pulled forward, when aperture 620 releases small tab 610 to allow shredder feeder cover to return to SHRED-SAFE/OFF position 430, NORMAL/ON position 420, or CLOSED/OFF position 410. Also, in the JAM CLEAR/OFF position 440, electrical power can be removed from the shredder motor and electronic components. In the JAM CLEAR/OFF position 440, users are protected from injury to their body parts, or belongings, introduced into the moveable paper feed throat 415, because the shredder motor and operating electronics are blocked from functioning. In the JAM CLEAR/OFF position 440, the moveable feed throat 415 can be manually returned, with a spring-loaded assist, to the SHRED-SAFE/OFF position 430.

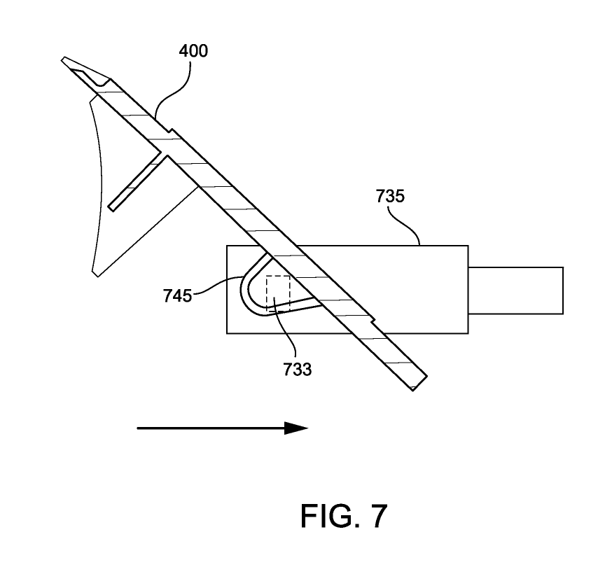

FIG. 7 illustrates a cut-away of JAM CLEAR/OFF position showing paper shredder plate 400 in the “up and moved back” position, relative to second safe power supply switch 735. The “up” position may be relative to the CLOSED position. Similarly, the “moved back” position may be moved away relative to the fixed vane of the shredder upper cover. Paper shredder plate 400 may have a protrusion 745 which depends from paper shredder plate 400. Protrusion 745 may have no contact with first safe power supply switch 212 while the shredder plate 400 is in the JAM CLEAR/OFF position. Or first safe power supply switch 212 may be designed to remove power to electrical components while in positions 410, 430, and 440. However, protrusion 745 can be designed to push in the operating plunger 733 on second safe power supply switch 735, causing power to be removed from the shredder electrical components. A third-level protection can be obtained by using second safe power supply switch 735 during clearing of a shredder jam.

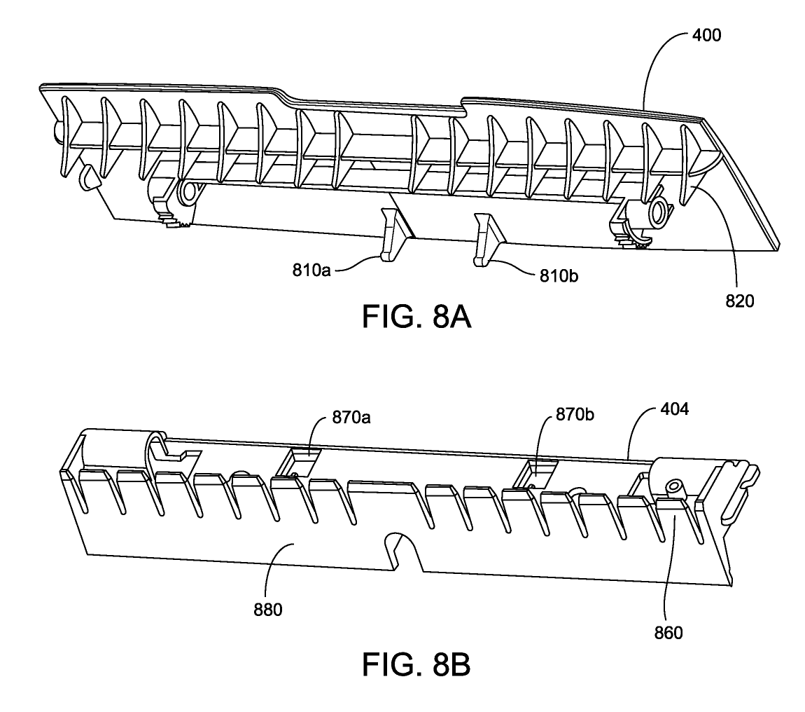

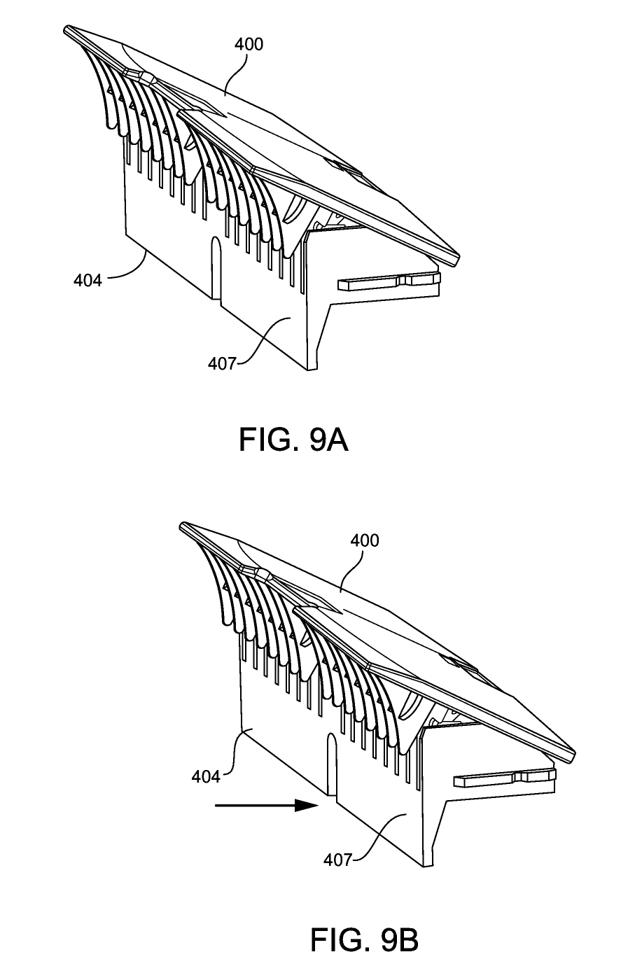

FIGS. 8A and 8B respectively depict top feed cover 400 and paper entrance board 450. Top feed cover 400 and paper entrance board 404 may be joined together to provide a structure such as paper shredder plate 500 in FIGS. 9A and 9B. In FIG. 8A, paper shredder plate 400 can be seen to include a plurality of generally vertical fingers, for example at 820, which can mesh in generally vertical slots 860 of paper entrance board 404, for example in FIG. 8B. Other forms of fingers and slots may be used. Tags 810a, 810b in feed cover 400 (FIG. 8A) can be designed to pass through openings 870a, 870b in paper entrance board 404 for coupling with apertures 620 in shredder cover top 402. Paper entrance board 404 may be moveable such that throat vane 407 can be a moveable throat vane.

JAM-CLEAR/OFF position 430 can be depicted in FIGS. 9A and 9B. FIG. 9A indicates that paper shredder plate 400 can be lifted up from CLOSED/OFF position 410 to one of NORMAL/ON position 420 or SHRED-SAFE/OFF position 430, without crossways moving paper entrance board 404 and thus, without crossways moving moveable throat vane 407. However, to achieve JAM CLEAR/OFF position 440, the user can push back (move crossways) paper shredder plate 400 and paper entrance board 404 away from SHRED-SAFE/OFF position 430 (in direction of arrow in FIG. 8B), to move back paper feed throat 415 and to achieve a greater gap width for paper feed throat 415 (e.g., about 7.2 mm total gap width). Tags 810a, 810b can releasably couple with, and be held by, apertures (not shown) in shredder upper cover 402. Electrical power can be removed from electrical portions of the shredder to help prevent injury while in SHRED-SAFE/OFF position 430 and JAM-CLEAR/OFF position 440.

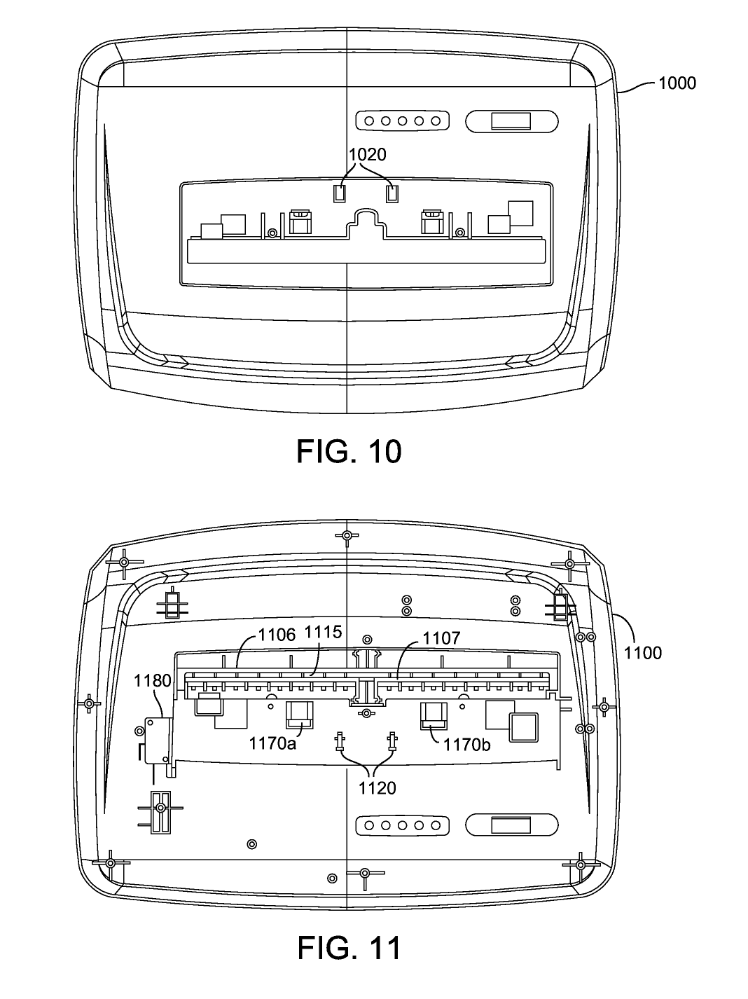

FIG. 10 and FIG. 11 respectively depict upper surface 1000 of shredder upper cover 402 and reverse surface 1100 of shredder upper cover 402. In FIG. 10 upper surface 1000 of shredder upper cover 402 is oriented upward, while in FIG. 11, reverse surface 1100 of shredder upper cover 402 is oriented downward. In FIG. 10, apertures 1020, and in FIG. 11, apertures 1120 in shredder upper cover 402, can be aligned with, and can releasably hold, shredder cover tags, such as tags 640 in FIG. 6. Apertures 1020 and 1120 can be like aperture 620 in FIG. 6. FIG. 11 also illustrates locations and relative positions of fixed throat vane 1106, moveable throat vane 1107, paper feed inlet 1115, apertures 1120, springs 1170a, 1170b, and power switch 780. Fixed throat vane 1106 and moveable throat vane 1107 together form moveable paper feed inlet 1115, similar to feed inlet 415. Springs 1170a, 1170b are depicted to be in compression, which can be used while in CLOSED/OFF position 410, NORMAL/ON position 420, and SHRED-SAFE/OFF position 430. In this configuration, springs 1170a, 1170b would be used in the extension position in JAM CLEAR/OFF position 440. However, springs 1170a, 1170b could be used in compression in JAM CLEAR/OFF position 440, and in extension in the other positions 410, 420, 430. Power switch 1180 can be used to energize the electrical shredder components (not shown) while in NORMAL/ON position 420, and to de-energize the electrical shredder components while in CLOSED/OFF position 410, in SHRED-SAFE/OFF position 430, or in JAM CLEAR/OFF position 440.

In summary, the present invention is very simply designed, and is easy to use. It features active protection and dual protection. Due to these characteristics, the present invention is very safe and very economical. While this specification describes the present invention in reference to the above specific embodiments, the present invention can be modified and transformed under its substantial spirit and within its substantial scope. Therefore, the specification and the drawings thereof are provided as descriptions of a preferred embodiment rather than limitations.

1. A novel safe paper feed opening structure of a paper shredder, comprising:
a shredder upper cover and a paper shredder plate, the shredder upper cover having an opening, and the paper shredder plate being disposed at the opening; and
the opening being in communication with a moveable feed throat, wherein the paper shredder plate is configured to be disposed in one of a plurality of positions,
wherein the moveable feed throat has a normal opening and a wide opening; and
wherein the paper feed throat is moved to the wide opening when the shredder plate is disposed in a preselected one of the plurality of positions.

2. The novel safe paper feed opening structure of claim 1, further comprising:
a touch structure/safe power supply switch, and the upper cover being correspondingly configured with a touch structure/safe power supply switch, the touch structure and the safe power supply switch being designed to interact with each other.

3. The novel safe paper feed opening structure of claim 1, wherein the moveable feed throat comprises a moveable throat vane and a fixed throat vane.

4. The novel safe paper feed opening structure of claim 1, wherein the paper shredder plate comprises a plurality of positions including:
a CLOSED position;
a NORMAL position;
a SHRED-SAFE position; and
a JAM CLEAR position.

5. The novel safe paper feed opening structure of claim 4, wherein the paper shredder plate comprises being disposed in:
a CLOSED/OFF position
a NORMAL/ON position;
a SHRED-SAFE/OFF position; or
a JAM CLEAR/OFF position,
wherein ON pertains to electrical power being supplied to the paper shredder electrical components, and wherein OFF pertains to electrical power being removed from the paper shredder electrical components.

6. The novel safe paper feed opening structure of claim 1, wherein a wide moveable feed throat opening corresponds to the JAM CLEAR/OFF position.

7. The novel safe paper feed opening structure of claim 3, wherein the fixed throat vane is a portion of the shredder upper cover and the moveable throat vane is a portion of a paper feed board coupled to the paper shredder plate.

8. The novel safe paper feed opening structure of claim 1, wherein the paper shredder plate is disposed in a CLOSED position, a power switch is in its OFF position, and the moveable feed throat is in the NORMAL opening.

9. The novel safe paper feed opening structure of claim 1, wherein the paper shredder plate is disposed in a NORMAL position, a power switch is in its ON position, and the moveable feed throat is in the NORMAL opening.

10. The novel safe paper feed opening structure of claim 1, wherein the paper shredder plate is disposed in a SHRED-SAFE position, a power switch is in its OFF position, and the moveable feed throat is in the NORMAL opening.

11. The novel safe paper feed opening structure of claim 1, wherein the paper shredder plate is disposed in a JAM CLEAR position, a power switch is in its OFF position, and the moveable feed throat is in the WIDE opening.

12. A method for operating a paper shredder, comprising:
providing a shredder upper cover;
providing the shredder upper cover with an opening;
disposing a paper shredder plate at the opening;
disposing the opening in communication with a moveable feed throat; and
moving the moveable feed throat in response to a paper shredder condition.

13. The method of claim 12, wherein moving comprises:
moving the moveable feed throat to a WIDE position in response to a paper shredder JAM condition.

14. The method of claim 13, further comprising turning OFF a safety switch, wherein the paper shredder is de-energized.

15. The method of claim 12, wherein moving comprises:
moving the moveable feed throat to a NORMAL position in response to a paper shredder NORMAL condition, wherein shreddable material is comminuted.

16. The method of claim 12, wherein moving further comprises one of:
moving the paper shredder plate to a CLOSED/OFF position;
moving the paper shredder plate to a NORMAL/ON position;
moving the paper shredder plate to a SHRED-SAFE/OFF position; or
moving the paper shredder plate to a JAM CLEAR/OFF position,
wherein ON corresponds to electrical power being supplied to electrical components of the paper shredder, and wherein OFF corresponds to electrical power being removed from the electrical components of the paper shredder.

17. A paper shredder comprising:
a shredder upper cover having an opening;
a moveable feed throat communicating with the opening and including a moveable throat vane and a fixed throat vane;
a paper shredder plate being disposed at the opening, wherein the opening is in communication with the moveable feed throat, wherein the paper shredder plate is configured to be disposed in one of a plurality of positions, wherein the moveable feed throat has a NORMAL opening and a WIDE opening corresponding to selected one of the plurality of positions;
a touch structure on the paper shredder plate; and
a safe power supply switch configured on the upper cover, wherein the touch structure and the safe power supply switch are designed to interact with each other.

18. The paper shredder of claim 17, wherein the paper shredder plate comprises being disposed in:
a CLOSED/OFF position
a NORMAL/ON position;
a SHRED-SAFE/OFF position; or
a JAM CLEAR/OFF position,
wherein ON corresponds to electrical power being supplied to paper shredder electrical components, and wherein OFF corresponds to electrical power being removed from the paper shredder electrical components.

19. The paper shredder of claim 17, wherein the safe power supply switch turns OFF when the paper shredder has a shreddable material jam in the moveable feed throat.
